(19) United States
(12) Patent Application Publication
(10) Pub. No.: US 2009/0019479 A1
(43) Pub. Date: Jan. 15, 2009

(54) IPTV CAPABLE OF AUTO CHANNEL SETTING AND METHOD THEREOF

(75) Inventors: Ki-won KWAK, Seongnam-si (KR); Chang-nam CHU, Yongin-si (KR); Chun-un KANG, Seoul (KR); Min-woo JUNG, Seoul (KR); Dae-hyun LEE, Seoul (KR); Jeong-su YUN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/037,129

(22) Filed: Feb. 26, 2008

(30) Foreign Application Priority Data
Jul. 13, 2007 (KR) 10-2007-0070649

(51) Int. Cl. H04N 5/445; H04N 7/173

(52) U.S. Cl. 725/38; 725/109

(57) ABSTRACT

An Internet Protocol Television (IPTV) capable of auto channel setting and a method thereof are provided. A channel information generating unit converts summaries of a plurality of web contents provided through the Internet into channel information as required by channel listing, and allocates channel numbers to the plurality of web contents, and a storage unit stores the allocated channel numbers and the generated channel information.

### CROSS-REFERENCE TO RELATED APPLICATION

This application claims priority from Korean Patent Application No. 2007-0070649, filed Jul. 13, 2007 in the Korean Intellectual Property Office, the entire disclosure of which is hereby incorporated by reference.

### BACKGROUND OF THE INVENTION

1. Field of the Invention

Apparatuses and methods consistent with the present invention relate to Internet Protocol Television (IPTV) capable of auto channel setting, and more particularly, to an IPTV capable of auto channel setting, which periodically collects summaries of each of web contents and provides the summaries in the form of channel data for TV service, and a method thereof.

2. Description of the Related Art

IPTV has recently achieved remarkable popularity due in part to the increasing use of the Internet. IPTV provides TV service not only from conventional terrestrial, cable and satellite broadcasts, but also from the Internet.

An IPTV provides the function of automatically setting channels. Upon request by a user, the IPTV detects channel numbers and program listings from the broadcast signal being provided from the associated terrestrial, cable, or satellite broadcast. The IPTV thus provides the user with a plurality of detected channel numbers and program listings.

However, a related art IPTV has a limited and fixed number of channels to scan and provide to a user, which limits the programs a user can view. While the related art IPTV provides TV service through the Internet, the IPTV does not automatically scan and provide a variety of Internet broadcasts and contents to users. The IPTV needs a separate menu structure to provide the function of Internet service channel setting, but this has had a difficulty in terms of program design.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide an IPTV having an auto channel setting function and a method thereof, which is capable of collecting information about a variety of web contents provided over the Internet, without having to set up a separate menu structure, and providing the collected information in the form of channel data to a user.

According to an aspect of the present invention, there is provided an IPTV having an auto channel setting function, including a channel information generating unit which converts summaries of a plurality of web contents provided through the Internet into channel information as required by channel listing, and which allocates channel numbers to the plurality of web contents, and a storage unit which stores the allocated channel numbers and the converted channel information.

The IPTV may further include an input unit which receives an auto channel setting command, and a display unit which displays the allocated channel numbers and the channel information in response to the auto channel setting command.

The IPTV may further include a collecting unit which collects from the Internet the summaries of the plurality of web contents.

The summaries of the plurality of web contents may be one of Really Simple Syndication (RSS) data and Any Transport over MPLS (ATOM) data.

The channel information may include titles and Uniform Resource Locations (URLs) of the web contents.

The IPTV may further include a signal receiving unit which receives broadcast signals of each of the channels provided from a terrestrial wave broadcast, a cable broadcast and a satellite broadcast, and a signal detecting unit which detects channel numbers and listing information of each of the channels from the received broadcast signals. Upon receipt of the auto channel setting command, the display unit may additionally display the channel numbers and listing information detected from the broadcast signals for each of the terrestrial wave broadcast, the cable broadcast, and the satellite broadcast.

Upon receipt of the auto channel setting command, the storage unit may store one of the displayed channel numbers that is selected through the input unit, and one of the channel information and the listing information corresponding to the selected channel number.

According to another aspect of the present invention, there is provided an auto channel setting method of an IPTV, including collecting summaries of a plurality of web contents through the Internet, generating channel information required by channel listing based on the collected summaries, and allocating channel numbers to the plurality of web contents, and storing the allocated channel numbers and the generated channel information.

The auto channel setting method may further include receiving an auto channel setting command, and displaying the allocated channel numbers and the channel information in response to the auto channel setting command.

The auto channel setting method may further include storing one of the displayed channel numbers that is selected through the input unit, and one of the channel information and the listing information corresponding to the selected channel number.

### BRIEF DESCRIPTION OF THE DRAWINGS

The above and other aspects of the present invention will be more apparent from the following detailed description of exemplary embodiments with reference to the accompanying drawings, in which:

FIG. 1 is a block diagram of a first IPTV capable of channel scanning according to a first exemplary embodiment of the present invention;

FIG. 2A illustrates an example of RSS data being collected over the Internet;

FIG. 2B illustrates an example of channel information being converted from the collected RSS data;

FIG. 3A illustrates an example of a User Interface (UI) indicating channel scan information related with a cable broadcast stored in a storage unit;

FIG. 3B illustrates an example of a UI indicating channel scan information related with RSS data stored in a storage unit;

FIG. 4 is a flowchart to explain the process for the IPTV of FIG. 1 to collect the summary information over the Internet and storing the channel information; and

FIG. 5 illustrates an example of a method for automatically setting channels of an IPTV according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

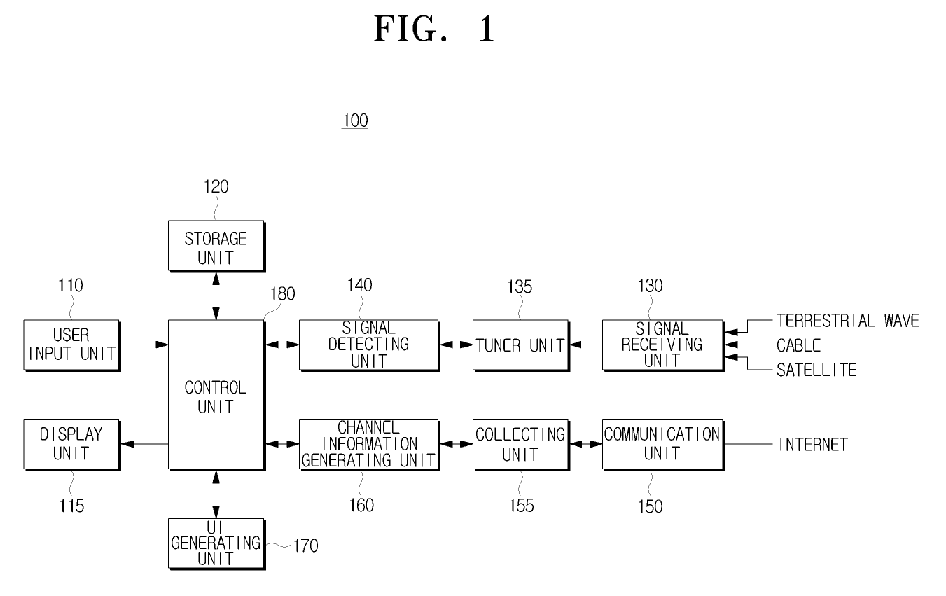

FIG. 1 is a block diagram of a first IPTV capable of channel scanning according to a first exemplary embodiment of the present invention. To briefly explain, the IPTV 100 is the representative TV service system that converges broadcast and communications, which provides a variety of services such as digital video service, bi-directional data service, or individually customized services, through an ultraspeed broadband network. The IPTV 100 provides auto channel setting function not only for the terrestrial, cable and satellite broadcasts, but also for the Internet. To this end, the IPTV 100 collects web contents-related information from among various information on the web, reconstructs the information into channel information, and upon input of an auto channel setting command, scans the restructured channel information and provides a user with the information.

Referring to FIG. 1, the IPTV 100 includes a user input unit 110, a display unit 115, a storage unit 120, a signal receiving unit 130, a tuner 135, a signal detecting unit 140, a communication unit 150, a collecting unit 155, a channel information generating unit 160, a UI generating unit 170, and a control unit 180.

The user input unit 110 may be provided in the remote controller or the IPTV 100, to receive a user command of auto channel setting and output it to the control unit 180. The auto channel setting includes the processes of scanning the effective channels of the terrestrial wave, cable and satellite broadcasts, scanning summary information of the web contents provided over the Internet, and providing a user with the information acquired.

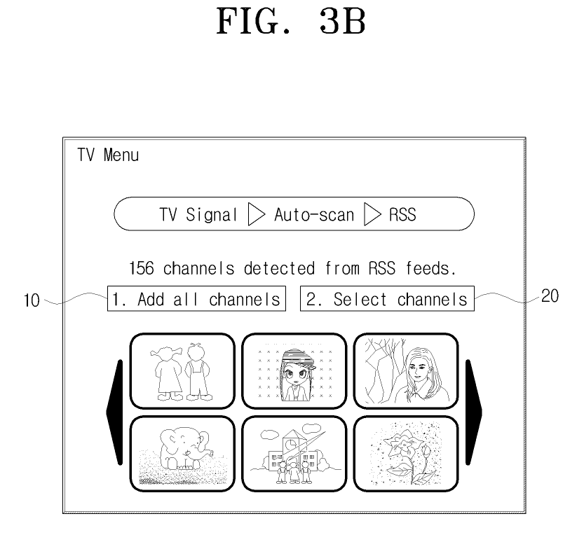

The display unit 115 presents the status of a channel search under the auto channel setting in the form exemplified in FIG. 3A. The display unit 115 also presents a UI that indicates the searched channels categorized by input types (FIG. 3B). The input types include terrestrial broadcast, cable broadcast, satellite broadcast, web contents, and any other sources that provide contents.

The storage unit 120 stores a variety of programs required by the IPTV 100 to operate. The storage unit 120 also stores channel numbers and program listings detected by the signal detecting unit 140, and stores channel information and channel numbers generated by the channel information generating unit 160. The storage unit 120 also stores the channel numbers that are selected by a user from among the stored channel numbers, and channel information or the program listings corresponding to the selected channel numbers.

The storage unit 120 also stores the URL or Internet Protocol (IP) address of a web site from which the collecting unit 155 collects the summary of web contents. The user may add or delete URL or IP addresses of desired web sites through the UI menu.

The signal receiving unit 130 receives broadcast signals provided from broadcast sources, including, terrestrial broadcast, cable broadcast, and satellite broadcast, respectively. To this purpose, the signal receiving unit 130 includes a terrestrial broadcast reception unit (not illustrated), a cable broadcast reception unit (not illustrated), and a satellite broadcast reception unit (not illustrated). The terrestrial, cable and satellite broadcast signals may take the form of analog data or digital data. In the description set forth below, the term “broadcast signal” will representatively refer to both the analog and digital data of each channel.

The tuner 135 tunes to the data of a channel selected by a user through the input unit 110 from among a plurality of channels being received through the signal receiving unit 130. The tuned data is processed into a displayable signal by a data processing logic (not illustrated) and displayed on the display unit 115.

The signal detecting unit 140 receives broadcast signals that correspond to a plurality of channels through the tuner 135, and detects the signal for channel setting. The signal detecting unit 140 detects channel numbers and program listings of the respective channels, from a plurality of broadcast signals being received at the signal receiving unit 130.

The channel numbers and program listings of the respective channels are then categorized into input types by the control unit 180 and stored in the storage unit 120. The input types include terrestrial, cable and satellite broadcasts. The signal detecting unit 140 operates as explained above, either according to a command for auto channel setting input through the user input unit 110, or with a predetermined periodicity.

The communication unit 150 hooks up to the Internet and receives a summary of a plurality of web contents. The communication unit 150 may be implemented as a physical device such as a Network Interface Card (NIC).

The collecting unit 155 collects through the communication unit 150 a summary of each of a plurality of web contents being provided through the Internet. Servers (not illustrated) provide a summary of the web contents that they provide, and a summary of the web contents may be collected at a single summary server (not illustrated). In this case, the collecting unit 155 accesses the summary server (not illustrated) through the communication unit 150 and the Internet, to collect the summary of the plurality of web contents.

The collecting unit 155 may exclusively collect a summary of the web contents that correspond to the URL or IP stored in the storage unit 120, or may collect a summary of all the web contents that are stored in the summary server (not illustrated). The collecting unit 155 may periodically operate to collect a summary of each of the web contents through the Internet, or may collect a summary upon receipt of an auto channel setting command from the user input unit 110.

The summary of each of the web contents may be provided in the form of RSS data or ATOM data. The RSS data and ATOM data Extensible Markup Language (XML)-based standards provided for the exchange and distribution of information between web sites. Many web sites support the RSS or ATOM standards. For example, web sites such as news, weather, shopping, or blog sites that require frequent updates generally provides RSS service, enabling a user to view the updated information from the sites using asynchronous communication, instead of visiting the sites, if he has an RSS address.

The RSS data will be explained below, as an example of composite data that contains a summary of each of the web contents therein.

The channel information generating unit 160 extracts data required for channel listing from the RSS data that contains the summaries of a plurality of web contents, generates channel information, and allocates channel numbers to each of the web contents. The data required for channel listing may include titles of the web contents, URLs of the web contents, or thumbnail images representing the web contents. In other words, the channel information includes titles of the web contents, URLs of the web contents, or thumbnail images representing the web contents.

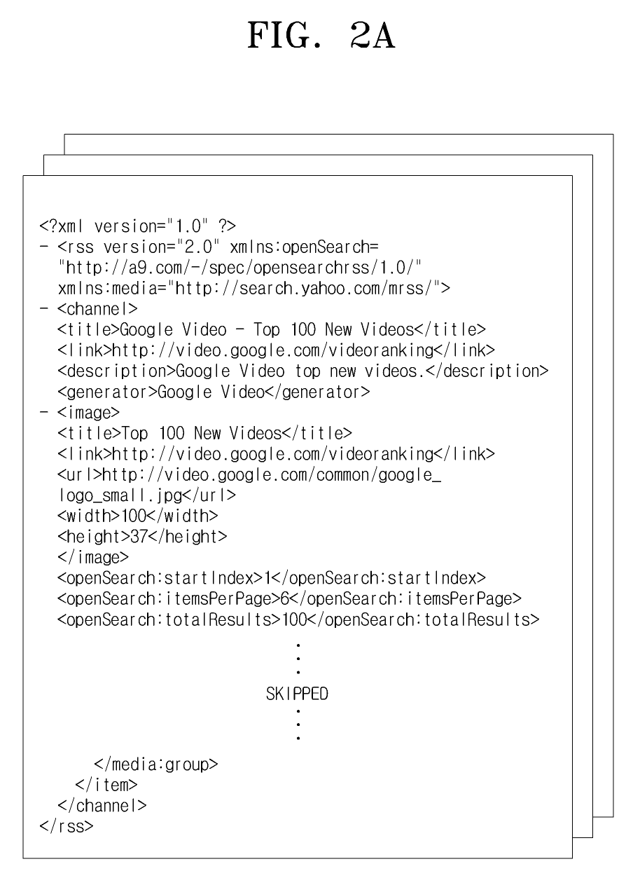

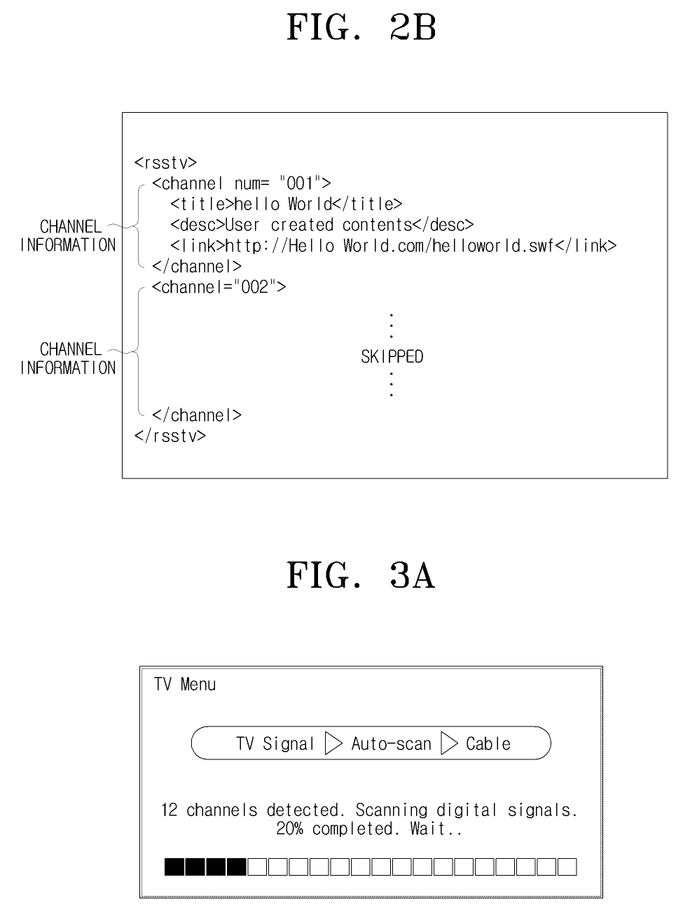

For example, if a plurality of summaries collected by the collecting unit 155 is the RSS data as shown in FIG. 2A, the channel information generating unit 160 extracts the titles of the web contents, the URLs of the web contents, or the thumbnail images from the summaries of the web contents included in the RSS data, generates the channel information, that is, the data structure required for the channel listing as shown in FIG. 2B, and allocates the channel numbers to each of the channel information.

The channel information may be generated for each of the web contents, or it may be converged for all the web contents. An example where the channel information is generated for each of the web contents will be explained below in detail.

The channel information generating unit 160 stores the channel information, allocated with channel numbers, in the storage unit 120. Accordingly, the storage unit 120 stores not only the channel numbers and listings provided by the cable broadcast and satellite broadcast, but also the channel numbers and listings of the web contents provided on the web.

Upon receiving an auto channel setting command from the user input unit 110, the UI generating unit 170 scans the storage unit 120, categorizes the information related to the detected channels according to the input types, and generates a UI that indicates a result of categorization. The UI generating unit 170 particularly generates a UI to provide information related with the channels being detected for each of the input types, and information related to the web channels being detected from the RSS data which is collected through the Internet.

FIG. 3A illustrates an example of a UI indicating channel scan information related to a cable broadcast stored in a storage unit, and FIG. 3B illustrates an example of a UI indicating channel scan information related to RSS data stored in a storage unit.

Referring to FIG. 3A, the UI indicates the number of channels provided by the cable broadcasts stored in the storage unit 120, and the progress of scanning the channels of the stored cable broadcasts. Referring to FIG. 3B, the UI indicates the number of web channels provided by the RSS data stored in the storage unit 120, and provides a UI to enable a user to select whether or not to store the web channel. For example, the control unit 180 may set all of the 156 web channels as auto channels, if a user selects a menu 10 through the user input unit 110, or may set only the web channels selected by a user to be auto channels to store in the storage unit 120, if a user selects a menu 20.

The control unit 180 carries out the above operations using a variety programs stored in the storage unit 120. The control unit 180 particularly controls the collecting unit 155 to periodically collect the RSS data, and controls the channel information generating unit 160 to generate channel information for each of the web contents from the collected RSS data and to allocate channel numbers. The control unit 180 also controls the signal detecting unit 140, upon receiving an auto channel setting command from the user input unit 110, so that the signal detecting unit 140 can detect from the broadcast signal the channel numbers and listing information which is provided according to the categories of input types.

The control unit 180 also stores, in the storage unit 120, the channel numbers and listing information or the channel information, either detected or allocated according to the categories of input types, and controls the UI generating unit 170 to scan the stored channel numbers and listing information and generate a UI that indicates the scanned information. For example, the UI generating unit 170 may scan the storage unit 120 in the order of terrestrial wave broadcast, cable broadcast, satellite broadcast, and RSS data, and generate a UI that indicates information related to the scanned channels.

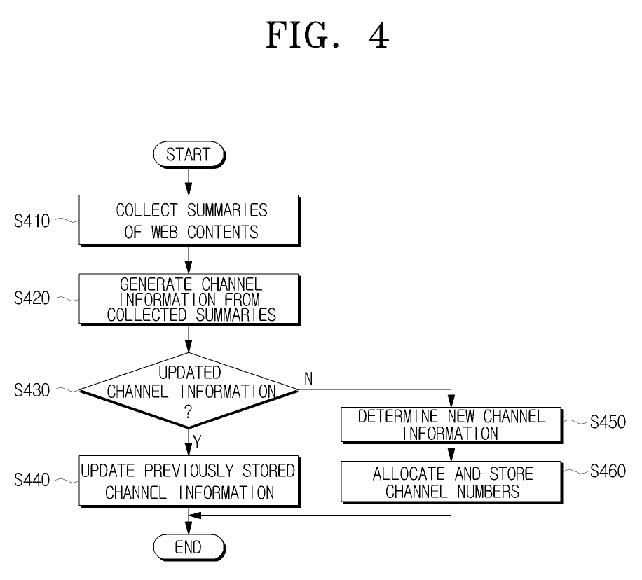

FIG. 4 is a flowchart to explain the process for the IPTV of FIG. 1 to collect the summary information over the Internet and store the channel information.

Referring to FIG. 4, at operation S410, the collecting unit 155 collects summaries of a plurality of web contents provided through the Internet. The collecting unit 155 may collect the summaries periodically, or upon receipt of an auto channel setting command from the user input unit 110. The summaries of the web contents are provided in the form of RSS data or ATOM data.

At operation S420, the channel information generating unit 160 extracts data required to construct a channel from the summaries of the web contents collected at operation S410, and generates channel information. The channel information includes URLs of the web contents, titles of the web contents, or thumbnail images representing the web contents. The channel information may be generated for each of the web contents.

If the generated channel information includes updated channel information at operation S430, at operation S440, the channel information generating unit 160 updates the previously stored channel information to the channel information which is generated at operation S420. If a URL that is same as that of the channel information generated at operation S420 is already stored at the storage unit 120, at operation S430, the channel information generating unit 160 compares to determine whether or not other types of channel information such as title or thumbnail are updated, and if determining that other types of channel information are updated, performs operation of S440.

If there is no updated channel information at operation S430, at operation S450, the channel information generating unit 160 determines that new channel information is generated, and at operation S460, allocates a new channel number and stores the new channel information in the storage unit 120.

As a plurality of web contents are provided through the Internet, the corresponding summaries are upgraded by being adapted to a form as required by channel listing and stored in the IPTV 100. As a result, a user is provided with upgraded web channel information.

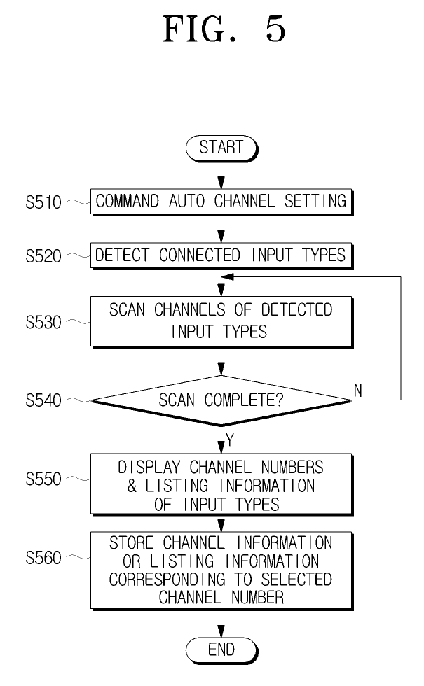

FIG. 5 is provided to explain an example of an auto channel setting method of an IPTV.

At operation S510, the user input unit 110 receives an auto channel setting command from a user, and at operation S520, the control unit 180 detects input types of the broadcast signals that are available for reception at the IPTV 100. For example, the control unit 180 may detect terrestrial wave broadcast, cable broadcast, and satellite broadcast as the input types of the broadcast signals connected with the signal receiving unit 130, and may also detect web contents as one of the input types, if the communication unit 150 is connected with the Internet.

After operation S520, and at operation S530, the control unit 180 scans the channels of the detected input types, respectively. The control unit 180 particularly controls the signal detecting unit 140 to detect the channel numbers and listing information from a plurality of broadcast signals being input through the signal receiving unit 130 and the tuner 135. The control unit 180 categorizes the channel numbers and listing information of the detected channels according to each of the input types, and temporarily stores the information in the storage unit 120. The control unit 180 also scans the storage unit 120 to detect the channel information for each of the previously stored web contents.

As the channel scan is completed at operation S540, at operation S550, the control unit 180 controls the UI generating unit 170 and the display unit 115 to generate a UI to indicate the channel numbers and information or listing information for each of input types, and to display the UI, respectively. The control unit 180 causes the UI to be generated and displayed for each of the input types. For example, the control unit 180 may cause to generate a UI in the order of a channel detected from terrestrial wave broadcast, a channel detected from cable broadcast, a channel detected from satellite broadcast, and a channel detected from the Internet.

At operation S550, if a user deletes or selects a channel number through the UI displayed for each of the input types, the control unit 180 causes the channel information or listing information corresponding to the selected channel number to be stored in the storage unit 120. For example, if a user selects 100 from 156 web channels through the UI, the control unit 180 causes the channel information corresponding to the selected 100 web channels to be stored in the storage unit 120.

With an IPTV having an auto channel setting function, and an auto channel setting method thereof according to the exemplary embodiments of the present invention, summaries of web contents are collected periodically and provided in the form of channel data for TV service. In other words, the number of web channels that can be set to be auto channels is virtually unlimited, because the RSS data or ATOM data are collected periodically and generated into a format as required by the channel listing.

According to the aspects of the present invention, a user can search the web channels with convenience, because web contents are provided in a channel format suitable for the navigation structure of an IPTV. Furthermore, most latest updated contents can be provided to a user, because summaries of the web contents are collected and stored in the form of channel data, either periodically, or upon request by a user. Furthermore, one will know the frequency of using the Internet contents in IPTV environment, by storing and analyzing the logs of the collected RSS data separately, and thus can use the obtained information in business activities such as web marketing or advertisements.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. An Internet Protocol Television (IPTV) having an auto channel setting function, the IPTV comprising:
a channel information generating unit which converts summaries of a plurality of web contents provided through the Internet into channel information, and which allocates channel numbers to the plurality of web contents; and
a storage unit which stores the allocated channel numbers and the converted channel information.

2. The IPTV of claim 1, further comprising:
an input unit which receives an auto channel setting command; and
a display unit which displays the allocated channel numbers and the channel information in response to the auto channel setting command.

3. The IPTV of claim 1, further comprising a collecting unit which collects from the Internet the summaries of the plurality of web contents.

4. The IPTV of claim 1, wherein the summaries of the plurality of web contents are one of Really Simple Syndication (RSS) data and Any Transport over MPLS (ATOM) data.

5. The IPTV of claim 1, wherein the channel information comprises titles and Uniform Resource Locations (URLs) of the web contents.

6. The IPTV of claim 2, further comprising:
a signal receiving unit which receives broadcast signals of each channel provided from a terrestrial wave broadcast, a cable broadcast and a satellite broadcast; and
a signal detecting unit which detects channel numbers and listing information of each of the channels from the received broadcast signals,
and wherein, upon receipt of the auto channel setting command, the display unit additionally displays the channel numbers and listing information detected from the broadcast signals for each of the terrestrial wave broadcast, the cable broadcast, and the satellite broadcast.

7. The IPTV of claim 6, wherein, upon receipt of the auto channel setting command, the storage unit stores one of the displayed channel numbers that is selected through the input unit, and one of the channel information and the listing information corresponding to the selected channel number.

8. An auto channel setting method of an Internet Protocol Television (IPTV), the method comprising:
collecting summaries of a plurality of web contents through the Internet;
generating channel information based on the collected summaries, and allocating channel numbers to the plurality of web contents; and
storing the allocated channel numbers and the generated channel information.

9. The auto channel setting method of claim 8, further comprising:
receiving an auto channel setting command; and
displaying the allocated channel numbers and the channel information in response to the auto channel setting command.

10. The auto channel setting method of claim 8, wherein the summaries of the plurality of web contents are one of Really Simple Syndication (RSS) data and Any Transport over MPLS (ATOM) data.

11. The auto channel setting method of claim 8, wherein the channel information comprises titles and Uniform Resource Locations (URLs) of the web contents.

12. The auto channel setting method of claim 9, further comprising:
receiving broadcast signals of each channel provided from a terrestrial wave broadcast, a cable broadcast and a satellite broadcast; and
detecting channel numbers and listing information of each of the channels from the received broadcast signals,
and wherein, upon receipt of the auto channel setting command, the displaying comprises additionally displaying the channel numbers and listing information detected from the broadcast signals for each of the terrestrial wave broadcast, the cable broadcast, and the satellite broadcast.

13. The auto channel setting method of claim 12, further comprising storing one of the displayed channel numbers that is selected through the input unit, and one of the channel information and the listing information corresponding to the selected channel number.
